(19) United States
(12) Patent Application Publication
(10) Pub. No.: US 2014/0306694 A1
(43) Pub. Date: Oct. 16, 2014

(54) DETERMINING DIRECTION OF AN OBJECT USING LOW FREQUENCY MAGNETIC FIELDS

(71) Applicant: Lyngsoe Systems Limited, Mississauga (CA)

(72) Inventors: Alex Oprea, Toronto (CA); Xiaohui Yu, Toronto (CA); Xiaojuan He, Mississauga (CA)

(73) Assignee: Lyngsoe Systems Limited, Mississauga (CA)

(21) Appl. No.: 14/254,612

(22) Filed: Apr. 16, 2014

Related U.S. Application Data
(60) Provisional application No. 61/812,466, filed on Apr. 16, 2013.

(51) Int. Cl. G06K 7/10; G06K 19/073; G01D 5/22; G06K 19/07

(52) U.S. Cl. CPC G06K 7/10425; G06K 7/10336; G06K 19/0723; G06K 19/073; G01D 5/2291
USPC 324/207.18; 235/439; 235/492

(57) ABSTRACT

A method for determining direction of travel of a tag is described. The method includes a tag that receives sample signals from two spatially separate LF magnetic fields generated by an exciter. The received signal strength indicator (RSSI) data associated with each of the sample signals is determined. A first RSSI profile is created for the first LF magnetic fields. A second RSSI profile is created for the second LF magnetic fields. The first and second RSSI profiles are compared to determine a direction of travel of the object. A tag, an exciter and a computer readable medium are configured to facilitate the method.

The present invention relates generally to determining a direction in which an object is travelling and specifically to a system and method using radio frequency identification (RFID) and low frequency magnetic fields to do so. This application claims priority from U.S. Provisional Application No. 61/812,466 filed Apr. 16, 2013.

### BACKGROUND

Radio-frequency identification (RFID) is a well-known technology that uses radio- frequency electromagnetic fields to transfer data for the purposes of automatically identifying and tracking objects by tags attached thereto. The tags contain electronically stored information which may be read from up to several meters away.

Although RFID is useful for identifying the objects, little information is available about the direction in which object is travelling. For example, it is often desirable to determine at a facility gateway whether the objects are entering or leaving the facility though the gateway.

Accordingly, it is desirable to be able to provide a system and method for determining a direction in which an object is travelling as it passes through a facility gateway.

### SUMMARY

In accordance with an aspect of an embodiment, there is provided an exciter comprising: a two directional coil comprising a first loop and a second loop, the first loop positioned orthogonal to and coaxial with the second loop; and a control circuit coupled to the two directional coil and configured to: activate the first loop and the second loop to create a first low frequency (LF) magnetic field and a second LF magnetic field, respectively; modulate the first magnetic field with a loop identifier for identifying the first loop; and modulate the second magnetic field with a loop identifier for identifying the second loop.

In accordance with a further aspect of an embodiment, there is provided a tag for coupling to an object, the tag comprising: an LF antenna; an LF receiver coupled to the LF antenna and configured to receive sample signals from an exciter; a microcontroller having stored thereon instructions which cause the microcontroller to: retrieve frame data from the sample signals, the frame data including a loop identifier identifying an originating one the loops of the exciter; and determine received signal strength indicator (RSSI) data associated with the sample signals.

In accordance with yet a further aspect of an embodiment, there is provided a method for determining direction of travel of a tag, the method comprising: receiving, at the tag, sample signals from two spatially separate LF magnetic fields generated by an exciter; determine received signal strength indicator (RSSI) data associated with each of the sample signals; creating a first RSSI profile for a first one of the LF magnetic fields; creating a second RSSI profile for a second one the LF magnetic fields; comparing the first and second RSSI profiles to determine a direction of travel of the object.

In accordance with yet a further aspect of an embodiment, there is provided a non-transitory computer readable medium having stored thereon instructions for determining direction of travel of a tag, the instructions which, when executed by a processing device, cause the processing device to: process received signal strength indicator (RSSI) data associated with each of a plurality of sample signals received from two spatially separate LF magnetic fields generated by an exciter; create a first RSSI profile for a first one of the LF magnetic fields; create a second RSSI profile for a second one the LF magnetic fields; and compare the first and second RSSI profiles to determine a direction of travel of the object.

### BRIEF DESCRIPTION OF THE DRAWINGS

Embodiments of the invention will now be described by way of example only with reference to the following drawings in which:

FIG. 1a is an isometric view of an exciter;

FIG. 1b is a cross section of the exciter magnetic field shown in FIG. 1;

FIG. 2 is a block diagram of an LF frame structure;

FIG. 3 is a block diagram of a tag;

FIG. 4 is front view of a gateway in a facility;

FIG. 5 is a flow chart illustrating steps taken to determine direction of an object; and

FIGS. 6a to 6e are sample RSSI profiles.

### DETAILED DESCRIPTION OF THE PREFERRED EMBODIMENTS

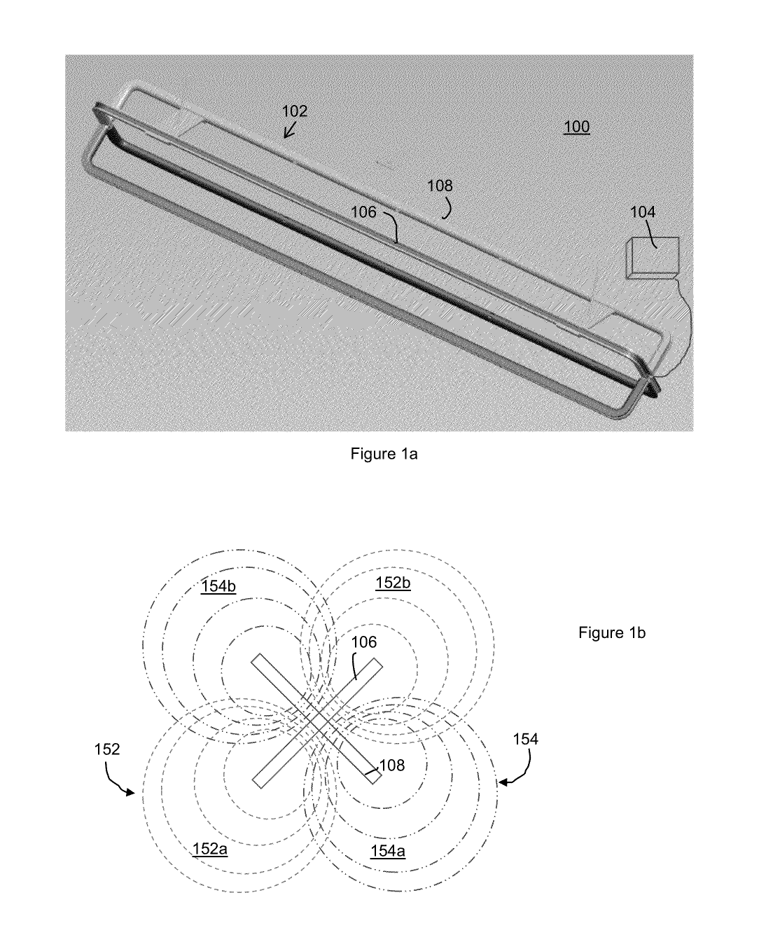

For convenience, like numerals in the description refer to like structures in the drawings. Referring to FIG. 1a, an exciter is illustrated generally by numeral 100. The exciter 100 comprises a two-directional (2D) exciter coil 102 and a control circuit 104. The exciter coil 102 includes a first loop 106 and a second loop 108. In this embodiment, both the first loop 106 and the second loop 108 are configured generally in the shape of a rectangle. The first loop 106 is orthogonal to the second loop 108. Furthermore, the first loop 106 is coaxial with the second loop 108.

Referring to FIG. 1b, a cross-sectional view of the magnetic field of the exciter 100 is shown. As shown, both the first loop 106 and the second loop 108 are at 45 degrees to the normal. The first loop 106 generates a first LF magnetic field 152 comprising a first inner region 152a and a first outer region 152b. Similarly, the second loop 108 generates a second LF magnetic field 154 comprising a second inner region 154a and an second outer region 154b. As will be described, the exciter 100 will be positioned proximate a doorway. The term “inner” is used to reference a region of the LF magnetic field 152 that is distributed towards the doorway. The term “outer” is used to reference a region of the LF magnetic field 152 that is distributed away from the doorway. In this embodiment, only the first inner region 152a and the second inner region 154a are of interest.

The control circuit 104 includes a power supply, a UHF antenna, a UHF receiver, a first LF driver to drive the first loop 106, a second LF driver to drive the second loop 108, a processor and a plurality of network connectors. The processor is coupled with the UHF receiver, the first loop driver, the second loop driver, and the plurality of network connectors. The UHF receiver is coupled with the UHF antenna. The UHF receiver and the processor are powered by the power supply. In this embodiment, the exciter 100 is connected to a persistent power supply of a facility in which it is installed. Further, in this embodiment the network connectors are wired connectors, such as Ethernet connecters, but may include other types of connectors such as RS232, universal serial bus (USB) and the like. Optionally, the network connectors may also include wireless connectors to facilitate wireless communication such as Wi-Fi or the like. Such network connectors are well known in the art and need not be discussed in greater detail.

The control circuit 104 is configured to drive a first current into the first loop 106 and a second current into the second loop 108 to generate a low frequency (LF) magnetic field. In this embodiment, the control circuit 104 is configured to generate an LF field at 65 kHz. This frequency was selected to reduce interference with other existing products offered by Lyngsoe Systems. However, as will be appreciated, other LF frequencies can be used. An LF magnetic field is selected because it is more confined that an ultra high frequency (UHF) electromagnetic field. Specifically, the LF magnetic field strength decays faster than the UHF electromagnetic field, in free space. The faster decay rate of the magnetic field makes it more confined in terms of distance. Furthermore, the UHF electromagnetic field suffers from reflection, diffraction, and refraction. This makes the field shape and intensity less predictable and more influenced by surrounding objects. Thus, using LF facilitates the generation of a confined field with a predictable intensity, that is, a sharp and well-defined decision region for directionality. In order to inhibit interference between the first loop 106 and the second loop 108, the control circuit activates the first loop 106 and the second loop 108 in an alternate fashion. Thus, when the first loop 106 is active, the second loop 108 is inactive and vice versa.

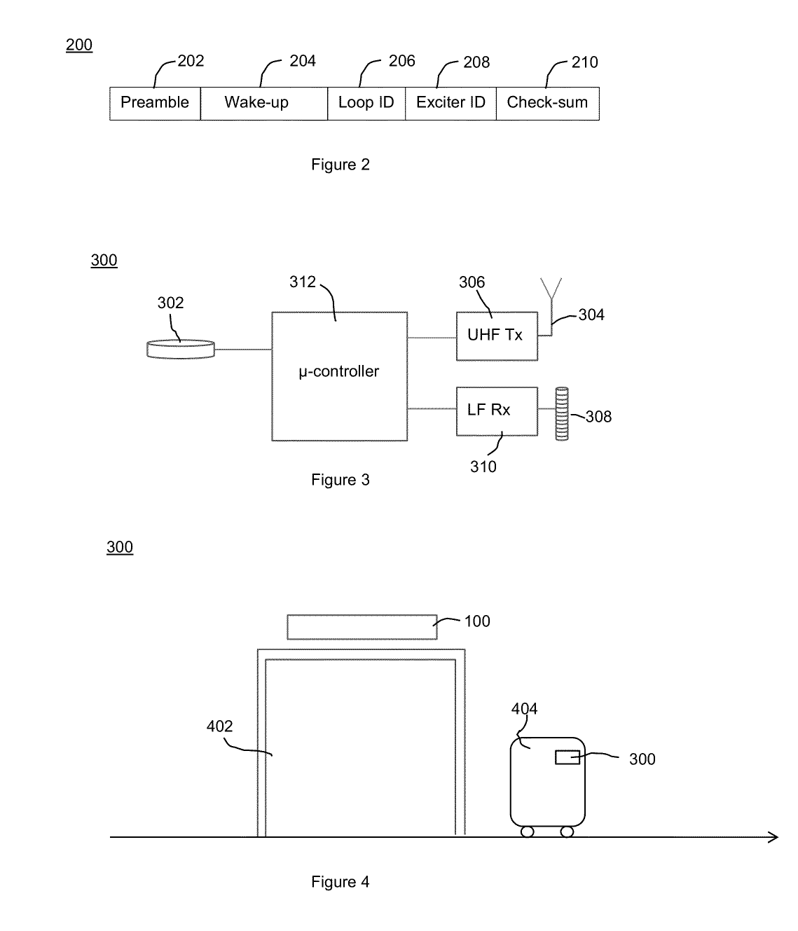

Furthermore, the control circuit 104 modulates the first and second currents with an LF frame using amplitude-shift keying (ASK) modulation. In this embodiment, the currents are modulated at a rate of 2 kbit/s. Referring to FIG. 2, an LF frame structure is illustrated generally by numeral 200. In this embodiment, the LF frame 200 includes a preamble 202, a wake-up pattern 204, a loop identifier 206, an exciter identifier 208 and a check sum 210. The preamble 202, the wake-up pattern 204 and the check sum 210 are known components of the LF frame 200. The loop identifier 206 identifies whether the LF frame was transmitted by the first loop 106 or the second loop 108. In this embodiment, the loop identifier 206 is a one-bit code in which 0 represents the first loop 106 and 1 represents the second loop 108. The exciter identifier 208 uniquely identifies the exciter coil 100.

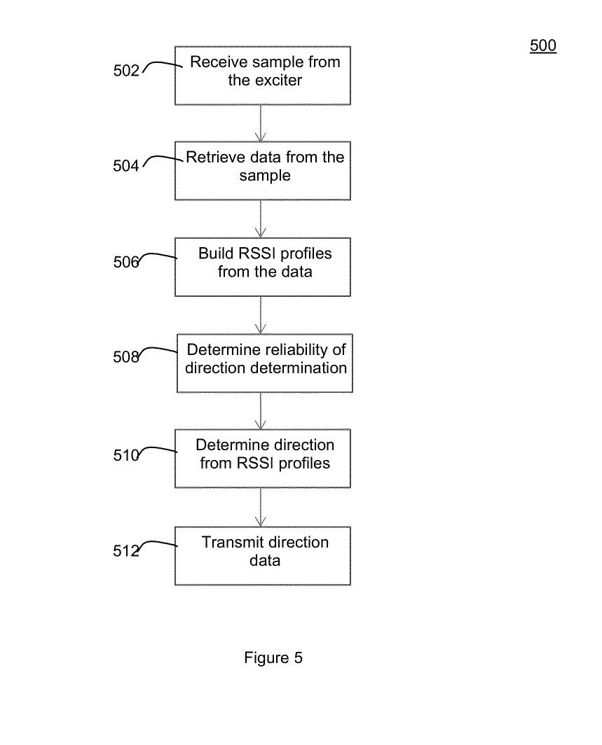

Referring to FIG. 3, an RFID tag in accordance with this embodiment is illustrated generally by numeral 300. The tag 300 includes a battery 302, a UHF antenna 304, a UHF transmitter 306, a LF antenna 308, a LF receiver 310 and a microcontroller 312. The microcontroller 312 is coupled with the LF receiver 310 and the UHF transmitter 306. The UHF transmitter 306 is coupled with the UHF antenna 304. The LF receiver 310 is coupled with the LF antenna 308. The microcontroller 312, the UHF transmitter 306 and the LF receiver 310 are powered by the battery 302.

In the present embodiment, the microcontroller 312 is configured to control the LF receiver 310. The microcontroller 312 is further configured to retrieve frame data, such as the loop identifier 206 and the exciter identifier 208, from received LF frames 200. The microcontroller 312 is further configured to determine corresponding received signal strength indicator (RSSI) data for the received LF frame 200. The microcontroller 312 may be further configured to transmit the retrieved frame data and corresponding RSSI data via the UHF transmitter 306, depending on the implementation, as will be described.

Referring once again to FIG. 1b, the ability of the tag 300 to readily distinguish between the two distinct magnetic fields 152 and 154 facilitates determination of directional information. For example, it can be determined that the tag 300 is initially within the first magnetic field 152 and transitions to the second magnetic field 154, suggesting a direction of travel from left to right. Conversely, it can be determined that the tag 300 is initially within the second magnetic field 154 and transitions to the first magnetic field 152, suggesting a direction of travel from right to left.

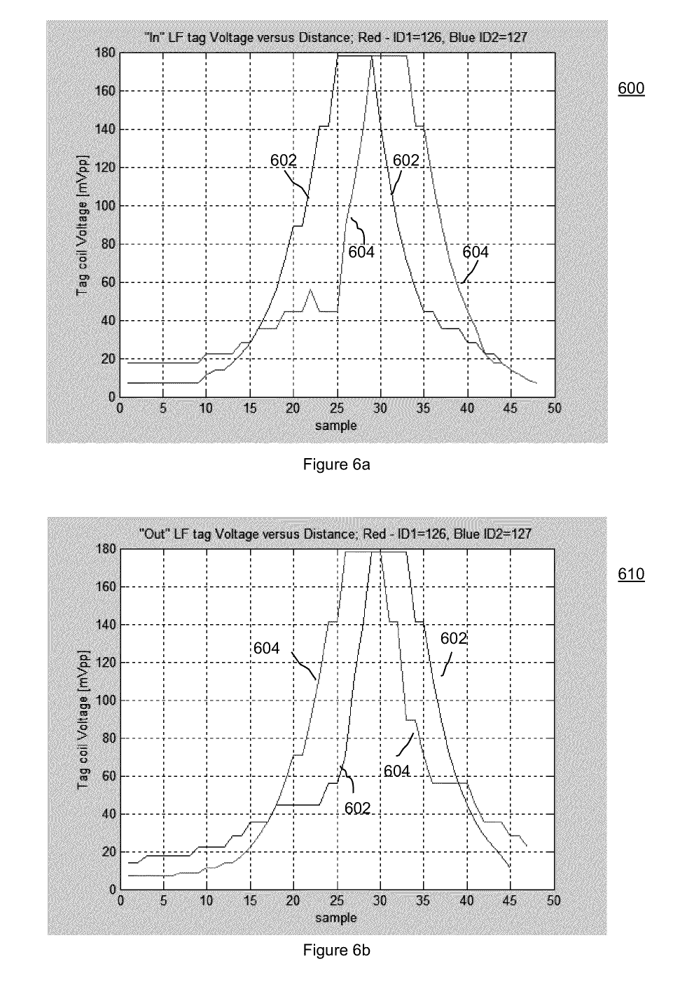

Referring to FIG. 4, a front view of a gateway to a facility is illustrated generally by numeral 400. The gateway 400 includes a door 402, such as a loading door, and an exciter 100 positioned above the door 402. The exciter 100 is positioned so that the first inner region 152a is generated substantially in front of the door 402 and the second inner region 154a is generated substantially behind the door 402, or vice versa. An object 404 can be manoeuvred in and out of the facility through the door 402. The object 404 is fitted with the tag 300 in order to facilitate determining the direction of the cage as it passes through the door 402. The tag is affixed to the object 404 so that the LF antenna 308 is vertically positioned.

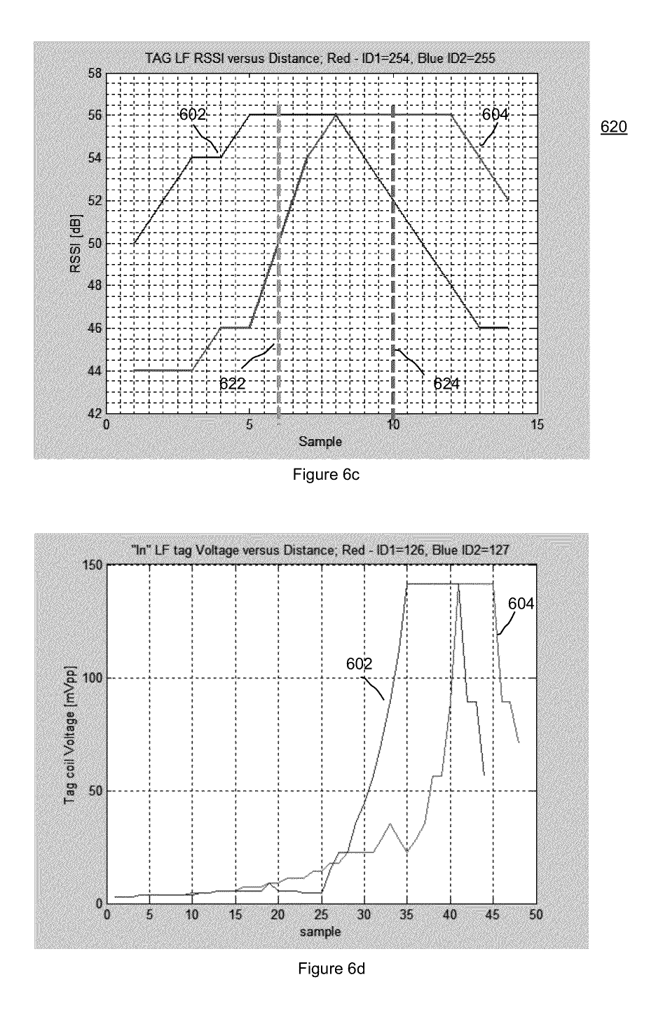

In this embodiment, the tag 300 is configured to determine the direction of travel of the object 404. Accordingly, the microcontroller 312 stores instructions to facilitate this determination. Referring to FIG. 5, a flow chart illustrating the steps taken by the microcontroller 312 to determine direction information is illustrated generally by numeral 500. At step 502, the microcontroller 312 receives a sample from the exciter 100. The sample includes one LF frame 200 from the first loop 106 and one LF frame 200 from the second loop 108. At step 504, the microcontroller 312 retrieves the frame data and the RSSI data from LF frames. In order to reduce the effect of stop-and-go motion of the object 404, the retrieved RSSI data for the sample is compared to the RSSI data for the previous sample. If there is no substantial difference, then it can be assumed that the object has slowed or stopped and the retrieved RSSI data can be discarded.

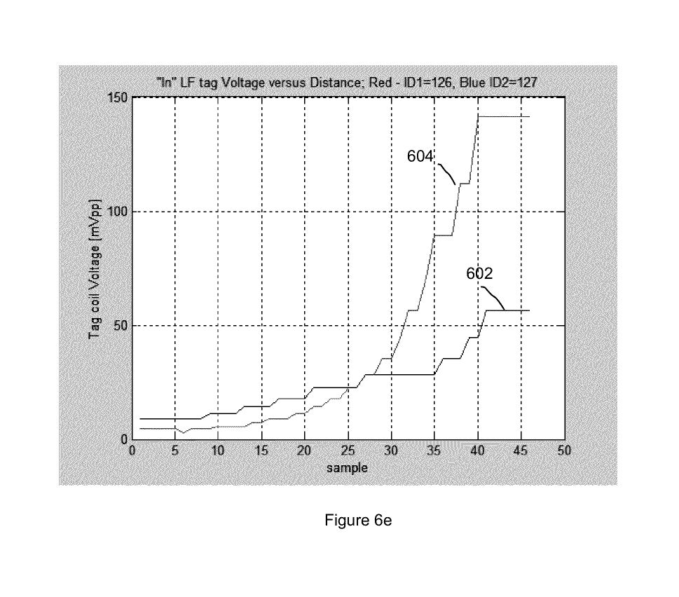

At step 506, the microcontroller 312 uses the retrieved frame data and the RSSI data to build an RSSI profile. Referring to FIG. 6a, an example of an RSSI profile is illustrated generally by numeral 600. In this example, a first magnetic field RSSI profile 602 is built for the first loop 106 and a second magnetic field RSSI profile 604 is built for the second loop 108. In order to limit the collection and possible transmission of samples that may not be useful, the microcontroller 312 may only store samples with an RSSI above a predefined RSSI threshold. Samples with an RSSI below the RSSI threshold may be discarded. In this embodiment, the threshold is determined once the RSSI profile has been built to inhibit discarding too many samples. A maximum value of the RSSI profile is used as a starting point. The threshold is defined as a percentage of the maximum value of the RSSI profile. For example, if the threshold is at 70%, then only the top 30 percentile of the samples are kept and the remaining samples are discarded or ignored. Alternately, the threshold can be defined as a predefined number of decibels (dB) below the maximum value of the RSSI profile. This results in a cropped RSSI profile. Referring to FIG. 6c, an example of a cropped RSSI profile is illustrated generally by numeral 620. Although this example does not correspond exactly with the example illustrated in FIG. 6a, the general principal that the cropped RSSI profile comprises only a top percentile of the RSSI profile is shown. The cropped RSSI profile is used for the following steps.

At step 508, the microcontroller 312 optionally determines the reliability of the cropped RSSI profile built at step 506 in order to determine directional information. One reliability metric that may be used by the microcontroller 312 is an area metric. The area metric is a comparison of the area of the first magnetic field RSSI profile 602 and the second magnetic field profile 604. Specifically, the microcontroller 312 determines an area ratio r_{α}. The area ratio is determined as

$${r}_{α} = \frac{{A}_{{RSSI}_{1}}}{{A}_{{RSSI}_{2}}} ,$$

wherein A_{RSSI1} is the area of the first magnetic field RSSI profile 602 and A_{RSSI2} is the area of the second magnetic field RSSI profile 602. If r_{α}≅1 then it is a good indicator that the determination of direction is reliable and the area metric is considered to be a pass. More specifically, in this embodiment, if 1.20≧r_{α}≧0.80 then the area metric is considered to be a pass. As will be appreciated by a person of ordinary skill in the art, the threshold that defines a pass can vary depending on the implementation. In the example illustrated in FIG. 6c, A_{RSSI1} is 682 and A_{RSSI2} is 666. Therefore, r_{α}=1.024≧1 and the area metric is considered to be a pass.

Another reliability metric that may be used by the microcontroller 312 is an abscissa metric. The abscissa metric is a comparison of the abscissa of the centres of the gravity of the first magnetic field RSSI profile 602 and the second magnetic field profile 604. Referring again to FIG. 6c, a first abscissa 622 of the centre of gravity for the first magnetic field RSSI profile 602 is determined to be approximately 6. A second abscissa 624 of the centre of gravity for the second magnetic field RSSI profile 604 is determined to be approximately 10. The microcontroller 312 determines and abscissa difference δ_{G}. The abscissa difference is determined as

$${δ}_{G} = \vert {x}_{{G}_{{A}_{{RSSI}_{1}}}} - {x}_{{G}_{{A}_{{RSSI}_{2}}}} \vert , \\ wherein$$

$${x}_{{G}_{{A}_{{RSSI}_{1}}}}$$

is the first abscissa 622 and

$${x}_{{G}_{{A}_{{RSSI}_{2}}}}$$

is the second abscissa 624. If δ_{G}≧2 then the abscissa metric is considered to be a pass. In the example illustrated in FIG. 6c, δ_{G}≈4≧2 and the determination of direction is considered to be a pass. Similar to the area metric, as will be appreciated by a person of ordinary skill in the art, the threshold that defines a pass can vary depending on the implementation.

At step 510, the microcontroller 312 uses the RSSI profile to determine the direction of the object 404. Once again, referring to FIG. 6c, the first magnetic field RSSI profile 602 occurs before the second magnetic field RSSI profile. Thus, it is apparent that the object is moving from the first magnetic field 152 toward the second magnetic field 154, and therefore out through the door 402. If the abscissa metric is determined in step 508, the direction of the object can be determined by comparing the first abscissa 622

$${x}_{{G}_{{A}_{{RSSI}_{1}}}}$$

and the second abscissa 624

$${x}_{{G}_{{A}_{{RSSI}_{2}}}} .$$

The RSSI profile having the smaller abscissa corresponds with the magnetic region that the tag 300 first encounters. The RSSI profile having the larger abscissa corresponds with the magnetic region that the tag 300 next encounters. Direction information is determined accordingly. Since the first abscissa 622 is approximately 6 and the second abscissa 624 is approximately 10, the object is moving from the first magnetic field 152 to the second magnetic field 154. Assuming the configuration described with reference to FIG. 4, the first inner region 152a is positioned in front of the door 402 and the second inner region 154a is position behind the door 402. Thus, the object 404 is moving out through the door 402.

At step 512, the microcontroller 312 transmits the direction, along with an identifier associated with the tag 300 using the UHF transmitter 306. The information transmitted by the tag 300 is received by the exciter 100, or another, separate reader. The information can then be transmitted to a remote computer, which may be executing management software to track the objects 404 throughout the facility. If the microcontroller 312 determined the reliability of the determination of direction, the reliability information may also be transmitted. Furthermore, if the reliability information indicates that the determination of direction is unreliable, the microcontroller may transmit the frame data and the corresponding RSSI data as well. The remote computer can use predefined algorithms to clean and/or enhance the RSSI data in an attempt to improve the reliability and make a proper determination of the direction. This calculation is performed at the remote computer, since it will likely have greater processing power and fewer power constraints than the tag 300. It may also be performed at the exciter 100, depending on the implementation.

Referring to FIG. 6b, another example of an RSSI profile is illustrated generally by numeral 610. In this example, the first magnetic field RSSI profile 602 for the first loop 106 occurs after a second magnetic field RSSI profile for the second loop 108. Thus, it is apparent that the object is moving from the second magnetic field 154 toward the first magnetic field 152, and therefore out through the door 402.

Referring to FIG. 6d, a sample RSSI profile for an object passing through the door 402 is shown. As will be appreciated, it is apparent from the RSSI profile that the object 404 is travelling in through the door 402. In this example, the RSSI profiles 602 and 604 are not symmetric since the object is passing through the door 402 at a diagonal path, rather than a path substantially parallel to the door. Referring to FIG. 6e, a sample RSSI profile for an object making a u-turn as it approaches the door 402 is shown. As will be appreciated, the object 404 does not pass through the door 402. Specifically, the second magnetic field RSSI profile 604 is significantly greater than the first magnetic field RSSI profile 602, suggesting that the object 404 approached the door 402 but did not exit the facility.

In the embodiment described above, only one door 402 to the facility is described for ease of explanation. In many circumstances, the facility will have a plurality of doors 402 side-by-side. Generally, the doors 402 are wide, often 3 m, however, they may be closely space with less than 1 m between doors. Accordingly, each door 402 is configured as a portal as described with reference to FIG. 4. Further, to inhibit interference between adjacent doors 402, the exciters 100 for adjacent doors 402 are activated an alternating fashion. Thus, consider for example, a facility with four doors in a row identified as Door 1, Door 2, Door 3 and Door 4. As noted above, each of the doors is approximately 3 m in length and spaced apart by approximately 1 m. Thus, Door 1 is approximately 4 m from Door 3 and Door 2 is approximately 4 m from Door 4. Accordingly, the exciter 100 associated with Door 1 will not significantly interfere with the exciter of Door 3. Similarly, the exciter 100 associated with Door 2 will not significantly interfere with the exciter of Door 4. Therefore, the exciters 100 associated with Door 1 and Door 3 are activated simultaneously while the exciters 100 associated with Door 2 and Door 4 are inactive. Conversely, the exciters 100 associated with Door 2 and Door 4 are activated simultaneously while the exciters 100 associate with Door 1 and Door 3 are inactive. The exciters 100 of all four doors can be daisy-chained, or otherwise communicatively coupled, in order to communicate control signals.

In the embodiments described above, the tag 300 is described as being an active tag 300 that receives data, manipulates the data, and transmits a result. In an alternative embodiment, the tag 300 may forward the data to the exciter 100 or the external reader without performing any data manipulation. Yet further, the tag 300 may be an LF passive tag and the exciter 100 or the external reader may be configured to determine RSSI data for associated frame data depending on the signals received from the passive tag.

In the embodiments described above, the control circuit 104 includes a UHF receiver and the tag 300 includes a UHF transmitter. In an alternate embodiment, the control circuit 104 and/or the tag 300 may include UHF transceivers to facilitate bi-directional communication using the UHF spectrum.

The system described above can be used on its own. Alternatively, it can be used in conjunction with other RFID tag reader systems such as Automatic Mail Quality Measurements (AMQM™) by Lyngsoe Systems. This would allow the system to determine the direction of the object 404 as well as identify items within the object on an individual level.

In the embodiments described above, the LF antenna 308 is described as being vertically positioned. In other embodiments, the orientation of the LF antenna 308 may vary depending on the type of antenna used. For example, if a three dimensional (3D) antenna is used the LF antenna 308 may take on almost any orientation.

In the embodiments described above, the exciter 100 is positioned horizontally above the door 402. In other embodiments, the exciter may be differently positioned. For example, the exciter 100 may be positioned vertically along one or both sides of the door 402. In another example, the exciter 100 may be buried in the ground beneath the door 402.

Using the foregoing specification, the invention may be implemented as a machine, process or article of manufacture by using standard programming and/or engineering techniques to produce programming software, firmware, hardware or any combination thereof.

Any resulting program(s), having computer-readable instructions, may be stored within one or more computer-usable media such as memory devices or transmitting devices, thereby making a computer program product or article of manufacture according to the invention. As such, functionality may be imparted on a physical device as a computer program existent as instructions on any computer-readable medium such as on any memory device or in any transmitting device, that are to be executed by a processor.

Examples of memory devices include, hard disk drives, diskettes, optical disks, magnetic tape, semiconductor memories such as FLASH, RAM, ROM, PROMS, and the like. Examples of networks include, but are not limited to, the Internet, intranets, telephone/modem-based network communication, hard-wired/cabled communication network, cellular communication, radio wave communication, satellite communication, and other stationary or mobile network systems/communication links.

A machine embodying the invention may involve one or more processing systems including, for example, computer processing unit (CPU) or processor, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

Although embodiments of the system have been shown and described above, those of skill in the art will appreciate that further variations and modifications may be made without departing from the scope of the invention as defined by the appended claims.

What is claimed is:

1. An exciter comprising:
a two directional coil comprising a first loop and a second loop, the first loop positioned orthogonal to and coaxial with the second loop; and
a control circuit coupled to the two directional coil and configured to:
activate the first loop and the second loop to create a first low frequency (LF) magnetic field and a second LF magnetic field, respectively;
modulate the first magnetic field with a loop identifier for identifying the first loop; and
modulate the second magnetic field with a loop identifier for identifying the second loop.

2. The exciter of claim 1 further comprising a receiver configured to receive received signal strength indicator (RSSI) data from a tag.

3. The exciter of claim 2, wherein the control circuit is further configured to:
based on the RSSI data, determine a first RSSI profile for the first LF magnetic field and a second RSSI profile for the second LF magnetic field; and
compare the first RSSI profile and the second RSSI profile to determine a direction of travel of the tag.

4. The exciter of claim 2, wherein the receiver is an ultra high frequency (UHF) transceiver configured for bidirectional communication with the tag.

5. A tag for coupling to an object, the tag comprising:
an LF antenna;
an LF receiver coupled to the LF antenna and configured to receive sample signals from an exciter;
a microcontroller having stored thereon instructions which cause the microcontroller to:
retrieve frame data from the sample signals, the frame data including a loop identifier identifying an originating one the loops of the exciter; and
determine received signal strength indicator (RSSI) data associated with the sample signals.

6. The tag of claim 5, wherein the microcontroller is further configured to
generate an RSSI profile for each of the loops of the exciter; and
compare the generated RSSI profiles to determine a direction of travel of the object.

7. The tag of claim 5, further comprising a transmitter to transmit the RSSI data to a reader.

8. The tag of claim 7, wherein the transmitter is an ultra high frequency (UHF) transceiver configured for bidirectional communication with the reader.

9. A method for determining direction of travel of a tag, the method comprising:
receiving, at the tag, sample signals from two spatially separate LF magnetic fields generated by an exciter;
determine received signal strength indicator (RSSI) data associated with each of the sample signals;
creating a first RSSI profile for a first one of the LF magnetic fields;
creating a second RSSI profile for a second one the LF magnetic fields;
comparing the first and second RSSI profiles to determine a direction of travel of the object.

10. The method of claim 9 further comprising discarding the RSSI data for a select one of the sample signals when the RSSI data for the select one of the sample signals is substantially the same as the RSSI data for a previously received sample signal.

11. The method of claim 9 further comprising discarding the RSSI data when the RSSI data is below a predefined RSSI threshold.

12. The method of claim 11, wherein RSSI threshold is determined as a percentage of a maximum value of a corresponding one of the first RSSI profile or the second RSSI profile.

13. The method of claim 11, wherein RSSI threshold is a predefined value below a maximum value of a corresponding one of the first RSSI profile or the second RSSI profile.

14. The method of claim 9 further comprising determining a reliability of the first RSSI profile and the second RSSI profile for determining the directions of travel of the object.

15. The method of claim 14, wherein the reliability is determined by:
calculating an area ratio as a ratio of an area of the first RSSI profile with respect to an area of the second RSSI profile; and
comparing the area ratio to a predefined range of values; and
determining that the determination of the direction of travel is reliable when the area ratio falls within the predefined range of values.

16. The method of claim 15, wherein the direction of travel is determined by:
identifying which of the first RSSI profile and the second RSSI profile occurs first; and
establishing the direction of travel of the object as from the space occupied by the LF magnetic field associated with the RSSI profile that occurs first to the space occupied by the LF magnetic field associated with the RSSI profile that occurs second.

17. The method of claim 14, wherein the reliability is determined by:
calculating first and second abscissas of centres of gravity for each of the first RSSI profile and the second RSSI profile, respectively; and
determining an abscissa difference between the first abscissa and the second abscissa; and
determining that the determination of the direction of travel is reliable when the abscissa difference is greater than a predefined abscissa threshold.

18. The method of claim 17, wherein the direction of travel is determined by:
identifying which of the first abscissa and the second abscissa occurs first; and
establishing the direction of travel of the object as from the space occupied by the LF magnetic field associated with the abscissa that occurs first to the space occupied by the LF magnetic field associated with the abscissa that occurs second.

19. The method of claim 9, wherein the direction of travel of the object is determined at the tag and communicated to a remote reader.

20. The method of claim 19, wherein the remote reader is the exciter.

21. The method of claim 14 further comprising when the a reliability of the first RSSI profile and the second RSSI profile are determined to be unreliable, further processing the RSSI data to enhance the RSSI data.

22. The method of claim 21, wherein the further processing of the RSSI data is performed remote from the tag.

23. A non-transitory computer readable medium having stored thereon instructions for determining direction of travel of a tag, the instructions which, when executed by a processing device, cause the processing device to:
process received signal strength indicator (RSSI) data associated with each of a plurality of sample signals received from two spatially separate LF magnetic fields generated by an exciter;
create a first RSSI profile for a first one of the LF magnetic fields;
create a second RSSI profile for a second one the LF magnetic fields; and
compare the first and second RSSI profiles to determine a direction of travel of the object.
